(19) United States
(12) Patent Application Publication
(10) Pub. No.: US 2023/0387974 A1
(43) Pub. Date: Nov. 30, 2023

(54) MEETING AN ERROR VECTOR MAGNITUDE REQUIREMENT

(71) Applicant: Lenovo (Singapore) Pte. Ltd., New Tech Park (SG)

(72) Inventor: Colin D. Frank, Park Ridge, IL (US)

(21) Appl. No.: 18/250,022

(22) PCT Filed: Oct. 23, 2021
(86) PCT No.: PCT/IB2021/059788

§ 371 Date: Apr. 21, 2023

Related U.S. Application Data
(60) Provisional application No. 63/105,012, filed on Oct. 23, 2020.

(51) Int. Cl. H04B 7/0456; H04W 52/36; H04W 52/38

(52) U.S. Cl. CPC H04B 7/0465; H04W 52/367; H04W 52/38

(57) ABSTRACT

Apparatuses, methods, and systems are disclosed for meeting an error vector magnitude (EVM) requirement. One method includes setting an EVM requirement for a transmit antenna within a set of transmit antennas of an antenna port. The EVM requirement for the transmit antenna is a EVM_{req}(m); EVM_{req} is the EVM requirement for the antenna port for a modulation; and a is based on a function of a number of transmit antennas of the antenna port. The method includes performing a transmission based on the EVM requirement.

### CROSS-REFERENCE TO RELATED APPLICATIONS

This application claims priority to U.S. Patent Application Ser. No. 63/105,012 entitled “APPARATUSES, METHODS, AND SYSTEMS FOR SPECIFYING MPR FOR AN ANTENNA PORT” and filed on Oct. 23, 2020 for Colin D. Frank, which is incorporated herein by reference in its entirety.

### FIELD

The subject matter disclosed herein relates generally to wireless communications and more particularly relates to meeting an error vector magnitude requirement.

### BACKGROUND

In certain wireless communications networks, EVM may be calculated. In such networks, the EVM may not be calculated correctly for certain conditions.

### BRIEF SUMMARY

Methods for meeting an error vector magnitude requirement are disclosed. Apparatuses and systems also perform the functions of the methods. One embodiment of a method includes setting, at a device, an error vector magnitude requirement for a transmit antenna within a set of transmit antennas of an antenna port. The error vector magnitude requirement for the transmit antenna is a EVM_{req}(m); EVM_{req} is the error vector magnitude requirement for the antenna port for a modulation; and a is based on a function of a number of transmit antennas of the antenna port. In some embodiments, the method includes performing a transmission based on the error vector magnitude requirement.

One apparatus for meeting an error vector magnitude requirement includes a device. In some embodiments, the apparatus includes a processor that: sets an error vector magnitude requirement for a transmit antenna within a set of transmit antennas of an antenna port, wherein: the error vector magnitude requirement for the transmit antenna is a EVM_{req}(m); EVM_{req} is the error vector magnitude requirement for the antenna port for a modulation; and a is based on a function of a number of transmit antennas of the antenna port; and performs a transmission based on the error vector magnitude requirement.

Another embodiment of a method for meeting an error vector magnitude requirement includes setting, at a device, a power reduction less than or equal to an allowed maximum power reduction for a transmit antenna within a set of transmit antennas to meet an error vector magnitude requirement for the transmit antenna. The error vector magnitude requirement for the transmit antenna is a EVM_{req}(m); EVM_{req} is the error vector magnitude requirement for the antenna port for a modulation; and a is based on a function of a number of transmit antennas of the antenna port. In some embodiments, the method includes performing a transmission based on the power reduction.

Another apparatus for meeting an error vector magnitude requirement includes a device. In some embodiments, the apparatus includes a processor that: sets a power reduction less than or equal to an allowed maximum power reduction for a transmit antenna within a set of transmit antennas to meet an error vector magnitude requirement for the transmit antenna, wherein: the error vector magnitude requirement for the transmit antenna is a EVM_{req}(m); EVM_{req} is the error vector magnitude requirement for the antenna port for a modulation; and a is based on a function of a number of transmit antennas of the antenna port; and performs a transmission based on the power reduction.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for meeting an error vector magnitude requirement;

FIG. 2 is a schematic block diagram illustrating one embodiment of an apparatus that may be used for meeting an error vector magnitude requirement;

FIG. 3 is a schematic block diagram illustrating one embodiment of an apparatus that may be used for meeting an error vector magnitude requirement;

FIG. 4 is a schematic block diagram illustrating one embodiment of a system for transmitting data;

FIG. 5 is a schematic block diagram illustrating one embodiment of a system for receiving data;

FIG. 6 is a flow chart diagram illustrating one embodiment of a method for meeting an error vector magnitude requirement; and

FIG. 7 is a flow chart diagram illustrating another embodiment of a method for meeting an error vector magnitude requirement.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

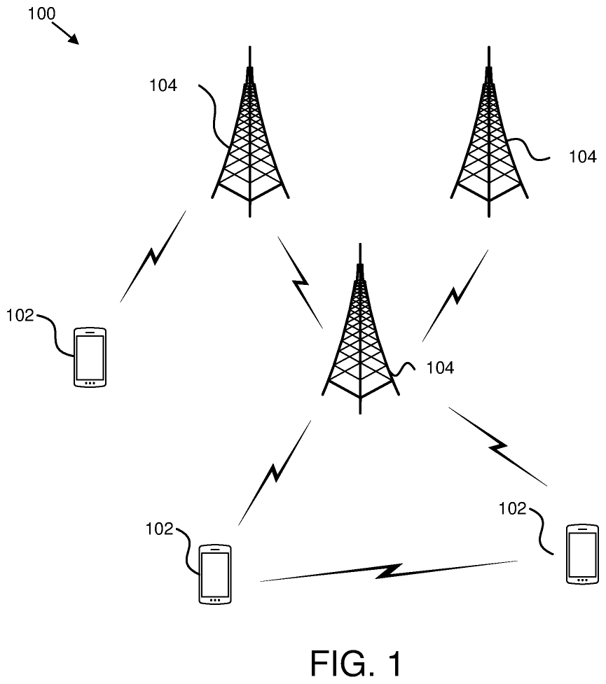

FIG. 1 depicts an embodiment of a wireless communication system 100 for meeting an error vector magnitude requirement. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 and/or a network unit 104 may set an error vector magnitude requirement for a transmit antenna within a set of transmit antennas of an antenna port. The error vector magnitude requirement for the transmit antenna is a EVM_{req}(m); EVM_{req} is the error vector magnitude requirement for the antenna port for a modulation; and a is based on a function of a number of transmit antennas of the antenna port. In some embodiments, the remote unit 102 and/or the network unit 104 may perform a transmission based on the error vector magnitude requirement. Accordingly, the remote unit 102 and/or the network unit 104 may be used for meeting an error vector magnitude requirement.

In certain embodiments, a remote unit 102 and/or a network unit 104 may set a power reduction less than or equal to an allowed maximum power reduction for a transmit antenna within a set of transmit antennas to meet an error vector magnitude requirement for the transmit antenna. The error vector magnitude requirement for the transmit antenna is a EVM_{req}(m); EVM_{req} is the error vector magnitude requirement for the antenna port for a modulation; and a is based on a function of a number of transmit antennas of the antenna port. In some embodiments, the remote unit 102 and/or the network unit 104 may perform a transmission based on the power reduction. Accordingly, the remote unit 102 and/or the network unit 104 may be used for meeting an error vector magnitude requirement.

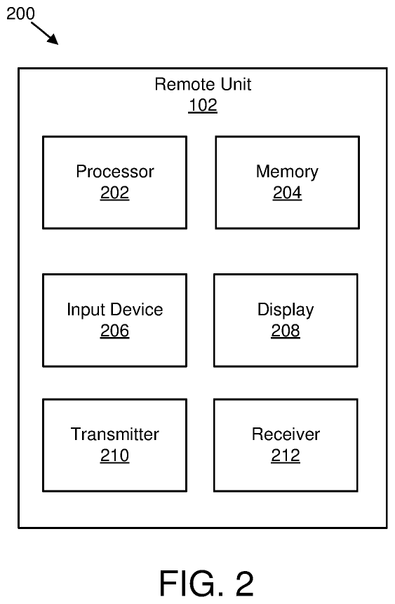

FIG. 2 depicts one embodiment of an apparatus 200 that may be used for meeting an error vector magnitude requirement. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202: sets an error vector magnitude requirement for a transmit antenna within a set of transmit antennas of an antenna port, wherein: the error vector magnitude requirement for the transmit antenna is a EVM_{req}(m); EVM_{req} is the error vector magnitude requirement for the antenna port for a modulation; and a is based on a function of a number of transmit antennas of the antenna port; and performs a transmission based on the error vector magnitude requirement.

In some embodiments, the processor 202: sets a power reduction less than or equal to an allowed maximum power reduction for a transmit antenna within a set of transmit antennas to meet an error vector magnitude requirement for the transmit antenna, wherein: the error vector magnitude requirement for the transmit antenna is a EVM_{req}(m); EVM_{req} is the error vector magnitude requirement for the antenna port for a modulation; and a is based on a function of a number of transmit antennas of the antenna port; and performs a transmission based on the power reduction.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

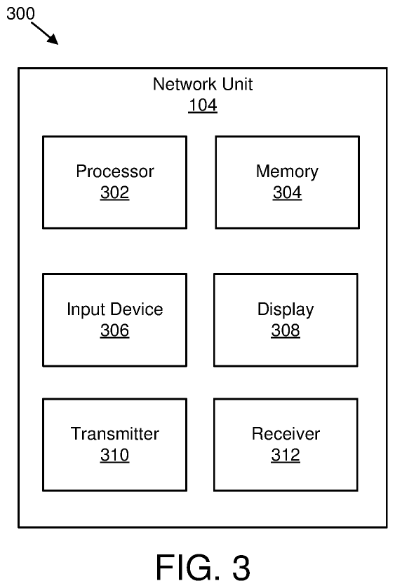

FIG. 3 depicts one embodiment of an apparatus 300 that may be used for meeting an error vector magnitude requirement. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302: sets an error vector magnitude requirement for a transmit antenna within a set of transmit antennas of an antenna port, wherein: the error vector magnitude requirement for the transmit antenna is a EVM_{req}(m); EVM_{req} is the error vector magnitude requirement for the antenna port for a modulation; and a is based on a function of a number of transmit antennas of the antenna port; and performs a transmission based on the error vector magnitude requirement.

In some embodiments, the processor 302: sets a power reduction less than or equal to an allowed maximum power reduction for a transmit antenna within a set of transmit antennas to meet an error vector magnitude requirement for the transmit antenna, wherein: the error vector magnitude requirement for the transmit antenna is a EVM_{req}(m); EVM_{req} is the error vector magnitude requirement for the antenna port for a modulation; and a is based on a function of a number of transmit antennas of the antenna port; and performs a transmission based on the power reduction.

In certain embodiments, a transmitter error vector magnitude (“EVM”) requirement may be used to put a lower bound on a link signal-to-noise ratio that is achievable for a radio link in the absence of any receiver impairments (e.g., thermal noise, channel estimation error, etc.). For single antenna transmission, EVM may be defined in terms of a signal-to-noise ratio of a signal constellation at an antenna connector. This may be because an ideal receiver may simply invert a channel and restore a signal to a same state as at a transmitter.

In some embodiments, to define EVM, an antenna port may include multiple physical antennas, and correspondingly, multiple antenna ports. In such embodiments, it may be necessary to determine a link signal-to-noise ratio. However, to determine the link signal-to-noise ratio, it may be necessary to make assumptions about both a number of receive antennas and a type of receiver that is used. Once the received signal-to-noise ratio has been determined for the ideal receiver, the EVM at the output of this receiver may be given by:

$$EVM = 100 \cdot \sqrt{\frac{1}{SNR}} .$$

In various embodiments, a transmitter port includes two physical antennas and a receiver has only a single physical antenna. In such embodiments, a channel may be such that the two transmitted signals cancel each other at the location of the receive antenna so that the received signal-to-noise ratio can be zero (e.g., negative infinity in dB). As a result, for the single antenna reception of a multi-antenna transmission (e.g., where the same signal is transmitted from both antennas except for complex weighting), there is no signal quality measure at the transmitter that can guarantee a link signal-to-noise greater than any target threshold greater than negative infinity. Furthermore, if the signals do not completely cancel, the received signal to noise ratio may still be a function of the channel, and there may be no transmitter requirement that can be defined which will remove the dependence of the received signal-to-noise ratio on the channel

In certain embodiments, for a single antenna reception of a multi-antenna transmission, there may be no transmit signal quality measure at a transmitter that can guarantee a received signal-to-noise greater than any target threshold greater than zero in linear terms. Furthermore, even for an ideal receiver, the received signal-to-noise ratio may always depend on a channel between the transmitter and the receiver.

In various embodiments, if determining a lower bound on an achievable link signal-to-noise ratio for a transmitter port having two physical antennas and two physical antenna connectors, it may be assumed that the receiver has at least two physical antennas.

In certain embodiments, to evaluate a signal-to-noise ratio at a receiver, a receiver algorithm may be defined. For a single layer transmission, at least two receivers may be considered when evaluating a signal-to-noise ratio that is subsequently used to determine a transmitter EVM. In some embodiments, at least three receivers may be considered for evaluating a signal-to-noise ratio and these may be: 1) a normalized conjugate-gain combiner; 2) a linear minimum mean-square error (“MMSE”) receiver; and 3) a linear unbiased minimum mean-square error (e.g., unbiased MMSE) receiver.

In various embodiments, a normalized conjugate-gain combiner is unbiased but is sub-optimal if a transmitter noise has unequal variance and/or is correlated. The second receiver, the MMSE receiver, may be biased so that the expected value of its output is conditioned on a data symbol and is not equal to the data symbol. Due to this bias, a mean-square error may not be measured correctly, and a signal-to-noise ratio may not correctly map to link performance. The third receiver, the linear unbiased MMSE receiver, may be optimal in a sense that it maximizes a received signal-to-noise ratio over a set of all linear unbiased receivers.

In certain embodiments, EVM for an antenna port with two physical antennas can be computed as shown herein. If the transmitter noise n at the two antenna connectors is observed to be independent so that the observed covariance matrix Σ= [symbol] n^{H}n [symbol] is diagonal, then the port EVM is given as:

$${EVM}_{port} = \sqrt{\frac{{EVM}_{1}^{2} {EVM}_{2}^{2}}{{EVM}_{1}^{2} {EVM}_{2}^{2}}} ,$$

where EVM₁ and EVM₂ are the EVM values for the first and second antenna connectors. If the transmitter noise is correlated so that Σ is not diagonal, then the EVM for the port or layer can be computed either as: EVMₚₒᵣₜ=100·\sqrt{(w^{H}Σ⁻¹w)⁻¹} or equivalently, as

$${EVM}_{port} = 100 \cdot {( {[ \begin{matrix}1 \\ 1\end{matrix} ]}^{H} {\sum }^{′ - 1} [ \begin{matrix}1 \\ 1\end{matrix} ] )}^{- \frac{1}{2}} ,$$

where w, Σ, and Σ′ are defined above.

In some embodiments, certain definitions are:

$$z = wx + n , [ \begin{matrix}{w}_{1} \\ {w}_{2}\end{matrix} ] = [ \begin{matrix}{g}_{1} & {w}_{1}^{′} \\ {g}_{2} & {w}_{2}^{′}\end{matrix} ] , \sum = E ( {n}^{H} n ) , {n}^{′} = [ \begin{matrix}{n}_{1}^{′} \\ {n}_{2}^{′}\end{matrix} ] = [ \begin{matrix}{\hat{w}}_{1}^{- 1} & {n}_{1} \\ {\hat{w}}_{2}^{- 1} & {n}_{2}\end{matrix} ] , and {\sum }^{′} = 〈 {n}^{′H} {n}^{′} 〉 .$$

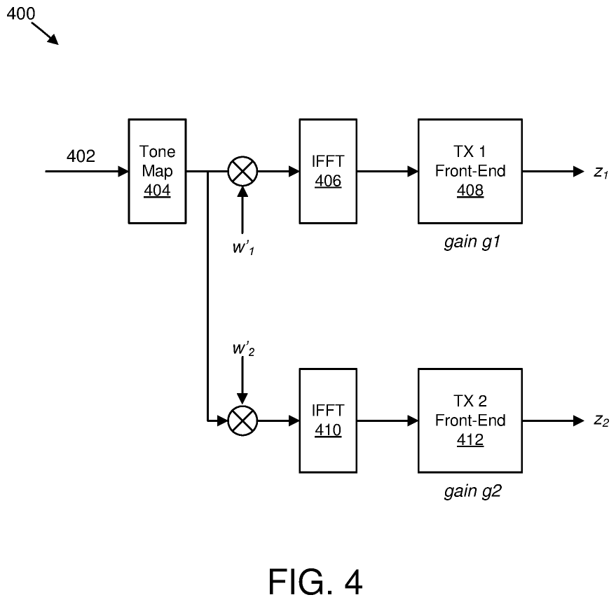

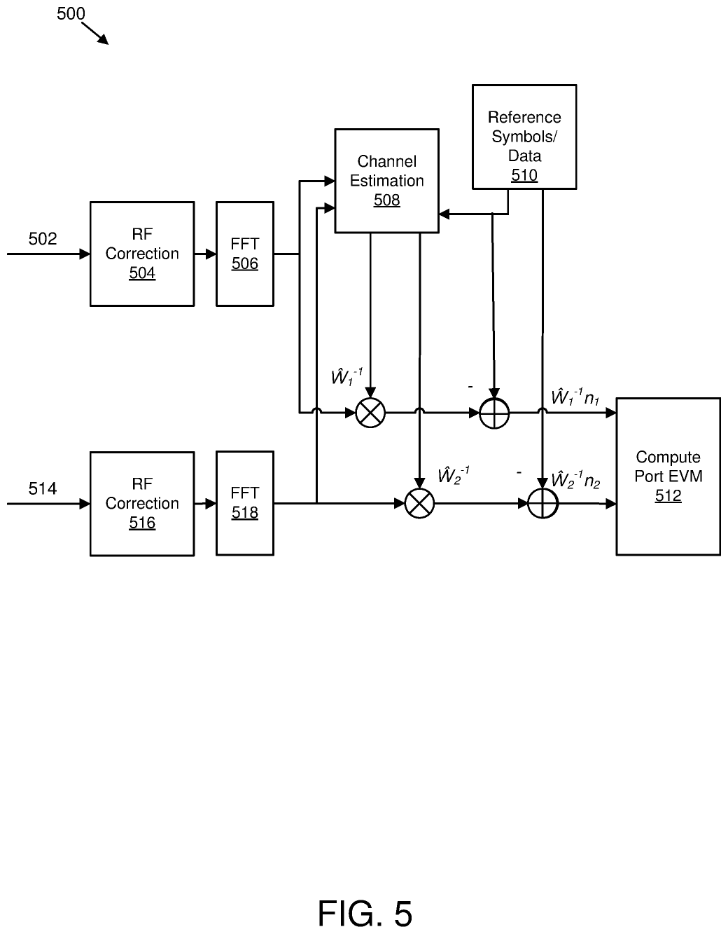

The vectors w′, ŵ, and g may be found in FIGS. 4 and 5.

FIG. 4 is a schematic block diagram illustrating one embodiment of a system 400 for transmitting data. Specifically, FIG. 4 illustrates one embodiment of a user equipment (“UE”) implementation of antenna port with two antennas. A signal 402 (e.g., cyclic prefix (“CP”) orthogonal frequency demodulation (“OFDM”), physical uplink shared channel (“PUSCH”), physical uplink control channel (“PUCCH”), demodulation reference signal (“DM-RS”)) may be received by a tone map 404. The signal 402 is multiplied by w′₁ and provided to an inverse fast Fourier transform (“IFFF”) 406, then provided to a first front end transmitter 408 (TX 1 front-end) using a gain g1 as a signal z₁. Moreover, the signal 402 is multiplied by w′₂ and provided to an IFFF 410, then provided to a second front end transmitter 412 (TX 2 front-end) using a gain g2 as a signal z₂.

FIG. 5 is a schematic block diagram illustrating one embodiment of a system 500 for receiving data. Specifically, FIG. 5 illustrates one embodiment of EVM measurement for an antenna port with two antennas. A first signal 502 is received and provided to radio frequency (“RF”) correction 504, then provided to a fast Fourier transform (“FFT”) 506, then provided to a channel estimation 508 and a summer. Reference symbols and/or data 510 are provided to the channel estimation 508 and additional summers which ultimately provide input to a computation module 512 that computes port EVM. A second signal 504 is similarly processed with an FFT 518, the channel estimation 508, the reference symbols and/or data 510, and the computation module 512.

Various embodiments described herein include an EVM calculation for two situations: 1) test equipment has a capability of measuring a covariance matrix Σ′ of transmitter noise of at the two antenna connectors; and 2) transmitter noise at two antenna connectors may be determined to be independent by the test equipment or the transmitter noise may be assumed to be independent.

In certain embodiments, test equipment may measure an EVM for first and second antenna connectors, but may not determine whether or not transmitter noise at the two antenna connectors is correlated or not or the value of the correlation. In some embodiments, it may be possible to determine a worst case EVM over all possible covariance matrices and use this to define EVM for the antenna port having two physical antennas and two antenna connectors.

In various embodiments, there may be a worst-case EVM if transmitter noise correlation is unknown. To see how the worst case EVM can be determined if the transmitter noise is correlated, let Σ′ be denoted as:

$${\sum }^{′} = [ \begin{matrix}{σ}_{1}^{2} & ε \\ {ε}^{*} & {σ}_{2}^{2}\end{matrix} ] , where ε = E [ ( {\hat{w}}_{1}^{- 1} {{n}_{1}}^{*} ) {\hat{w}}_{2}^{- 1} {n}_{2} ] .$$

The inverse of Σ′ is given by

$${( {\sum }^{′} )}^{- 1} = \frac{( \begin{matrix}{σ}_{2}^{2} & - {ε}^{*} \\ - ε & {σ}_{1}^{2}\end{matrix} )}{{σ}_{1}^{2} {σ}_{2}^{2} - {\vert ε \vert}^{2}} .$$

We then have

$${( \frac{{EVM}_{port}}{100} )}^{2} = {( [ \begin{matrix}1 & {1 ]}^{H} {\sum }^{′ - 1} [ \begin{matrix}1 \\ 1\end{matrix}\end{matrix} ] )}^{- 1} = {( \frac{{σ}_{1}^{2} + {σ}_{2}^{2} - 2 Re ( ε )}{{σ}_{1}^{2} {σ}_{2}^{2} - {\vert ε \vert}^{2}} )}^{- 1} = \frac{{σ}_{1}^{2} {σ}_{2}^{2} - {\vert ε \vert}^{2}}{{σ}_{1}^{2} + {σ}_{2}^{2} - 2 Re ( ε )} \leq \frac{{σ}_{1}^{2} {σ}_{2}^{2} - {\vert ε \vert}^{2}}{{σ}_{1}^{2} + {σ}_{2}^{2} - 2 \vert ε \vert} ,$$

where the denominator is maximized for a given magnitude of ε when ε is real and positive. So, if we know the magnitude of ε but not the phase, then we have

$${( \frac{{EVM}_{port}}{100} )}^{2} \leq \frac{{σ}_{1}^{2} {σ}_{2}^{2} - {\vert ε \vert}^{2}}{{σ}_{1}^{2} + {σ}_{2}^{2} - 2 \vert ε \vert} ,$$

From which it follows that:

$${EVM}_{port} \leq 100 \sqrt{\frac{{10}^{- 8} {EVM}_{1}^{2} {EVM}_{2}^{2} - {\vert ε \vert}^{2}}{{10}^{- 4} {EVM}_{1}^{2} + {10}^{- 4} {EVM}_{2}^{2} - 2 \vert ε \vert}} , \sqrt{\frac{{EVM}_{1}^{2} {EVM}_{2}^{2} - {10}^{8} {\vert ε \vert}^{2}}{{EVM}_{1}^{2} + {EVM}_{2}^{2} - 2 {10}^{4} \vert ε \vert}} .$$

The value of |ε| which maximizes this expression may be found by taking the derivative with respect to |ε| and setting the result equal to 0, with the result that:

$$\frac{\partial }{\partial \vert ε \vert} \{ \frac{{σ}_{1}^{2} {σ}_{2}^{2} - {\vert ε \vert}^{2}}{{σ}_{1}^{2} + {σ}_{2}^{2} - 2 \vert ε \vert} \} = \frac{- 2 \vert ε \vert}{{σ}_{1}^{2} + {σ}_{2}^{2} - 2 \vert ε \vert} + \frac{2 ( {σ}_{1}^{2} {σ}_{2}^{2} - {\vert ε \vert}^{2} )}{{( {σ}_{1}^{2} + {σ}_{2}^{2} - 2 \vert ε \vert )}^{2}} = \frac{- 2 \vert ε \vert ( {σ}_{1}^{2} + {σ}_{2}^{2} - 2 \vert ε \vert ) + 2 ( {σ}_{1}^{2} {σ}_{2}^{2} - {\vert ε \vert}^{2} )}{{( {σ}_{1}^{2} + {σ}_{2}^{2} - 2 \vert ε \vert )}^{2}} = 0 ,$$

where the denominator is non-zero unless σ₁²=σ₂² and |ε|=σ₁².

Setting the numerator equal to 0, yields:

−2|ε|σ₁²−2|ε|σ₂²+4|ε|²+2σ₁²σ₂²−2|ε|²=2(|ε|²−|ε|σ₁²−|ε|σ₂²+σ₁²σ₂²)

=2(|ε|−σ₁²)(|ε|−σ₂²)=0

where the zeros occur for |ε|=σ₁² and |ε|=σ₂². Now, since |ε|≤σ₁σ₂ (because the covariance matrix is positive definite) it follows that if max(σ₁², σ₂²)=σ₁², then |ε|≤σ₂² and only the zero at |ε|=σ₂² can be achieved. Conversely, if max(σ₁², σ₂²)=σ₂², then |ε| is strictly less than σ₁², and only the zero at |ε|=σ₁² can be achieved.

To ensure that the zero of the derivative is a maximum and not a minimum, it is necessary to evaluate the second derivate at these zeros. The second derivate is given by:

$$\begin{matrix}\frac{{\partial }^{2}}{{\partial }^{2} \vert ε \vert} \{ \frac{{σ}_{1}^{2} {σ}_{2}^{2} - \vert ε {\vert}^{2}}{{σ}_{1}^{2} + {σ}_{2}^{2} - 2 \vert ε \vert} \} = \frac{\partial }{\partial \vert ε \vert} \{ \frac{2 ( \vert ε {\vert}^{2} - \vert ε \vert {σ}_{1}^{2} - \vert ε \vert {σ}_{2}^{2} + {σ}_{1}^{2} {σ}_{2}^{2} )}{{( {σ}_{1}^{2} + {σ}_{2}^{2} - 2 \vert ε \vert )}^{2}} \} \\ = \begin{matrix}\frac{4 \vert ε \vert - 2 {σ}_{1}^{2} - 2 {σ}_{2}^{2}}{{( {σ}_{1}^{2} + {σ}_{2}^{2} - 2 \vert ε \vert )}^{2}} + \\ \frac{8 ( \vert ε {\vert}^{2} - \vert ε \vert {σ}_{1}^{2} - \vert ε \vert {σ}_{2}^{2} + {σ}_{1}^{2} {σ}_{2}^{2} )}{{( {σ}_{1}^{2} + {σ}_{2}^{2} - 2 \vert ε \vert )}^{3}}\end{matrix} \\ = \frac{\begin{matrix}( 4 \vert ε \vert - 2 {σ}_{1}^{2} - 2 {σ}_{2}^{2} ) ( {σ}_{1}^{2} + {σ}_{2}^{2} - 2 \vert ε \vert ) + \\ 8 ( \vert ε {\vert}^{2} - \vert ε \vert {σ}_{1}^{2} - \vert ε \vert {σ}_{2}^{2} + {σ}_{1}^{2} {σ}_{2}^{2} )\end{matrix}}{{( {σ}_{1}^{2} + {σ}_{2}^{2} - 2 \vert ε \vert )}^{3}} \\ = \frac{4 {σ}_{1}^{2} {σ}_{2}^{2} - 2 {σ}_{1}^{4} - 2 {σ}_{2}^{4}}{{( {σ}_{1}^{2} + {σ}_{2}^{2} - 2 \vert ε \vert )}^{3}} = \frac{- 2 {( {σ}_{1}^{2} - {σ}_{2}^{2} )}^{2}}{{( {σ}_{1}^{2} + {σ}_{2}^{2} - 2 \vert ε \vert )}^{3}}\end{matrix}$$

In the above expression, the numerator is negative for all values of σ₁² and σ₂² other than σ₁²=σ₂², in which case the value is 0. The denominator is always positive except in the case that σ₁²=σ₂² and |ε|=σ₁². As a result, the second derivative is zero, and the zero location of the first derivative is a maximum.

When max(σ₁², σ₂²)=σ₂², the maximum occurs for |ε|=σ₁², and

$${( \frac{E V {M}_{p o r t}}{100} )}^{2} \leq \frac{{σ}_{1}^{2} {σ}_{2}^{2} - \vert ε {\vert}^{2}}{{σ}_{1}^{2} + {σ}_{2}^{2} - 2 \vert ε \vert} = \frac{{σ}_{1}^{2} {σ}_{2}^{2} - {σ}_{1}^{4}}{{σ}_{1}^{2} + {σ}_{2}^{2} - 2 {σ}_{1}^{2}} = \frac{{σ}_{1}^{2} ( {σ}_{2}^{2} - {σ}_{1}^{2} )}{( {σ}_{2}^{2} - {σ}_{1}^{2} )} = {σ}_{1}^{2} = min ( {σ}_{1}^{2} , {σ}_{2}^{2} )$$

Conversely, when max(σ₁², σ₂²)=σ₁², the maximum occurs

$$\vert ε \vert = {σ}_{2}^{2} , and {( \frac{{EVM}_{port}}{100} )}^{2} \leq \frac{{σ}_{1}^{2} {σ}_{2}^{2} - \vert ε {\vert}^{2}}{{σ}_{1}^{2} + {σ}_{2}^{2} - 2 \vert ε \vert} = \frac{{σ}_{1}^{2} {σ}_{2}^{2} - {σ}_{2}^{4}}{{σ}_{1}^{2} + {σ}_{2}^{2} - 2 {σ}_{2}^{2}} = \frac{{σ}_{2}^{2} ( {σ}_{1}^{2} - {σ}_{2}^{2} )}{( {σ}_{1}^{2} - {σ}_{2}^{2} )} = {σ}_{2}^{2} = min ( {σ}_{1}^{2} , {σ}_{2}^{2} )$$

So, regardless of whether max(σ₁², σ₂²)=σ₁² or max(σ₁², σ₂²)=σ₂², we have the same result that

$${( \frac{E V {M}_{p o r t}}{100} )}^{2} \leq min ( {σ}_{1}^{2} , {σ}_{2}^{2} ) ,$$

from which it follows that:

EVMₚₒᵣₜ≤100\sqrt{min(σ₁², σ₂²)}=min(100\sqrt{σ₁²},100\sqrt{σ₂²})=min(EVM₁,EVM₂)

and finally, EVMₚₒᵣₜ≤min(EVM₁,EVM₂).

In certain embodiments, there may be a worst-case EVM as a function of transmitter noise correlation. From the expression above, the port EVM as a function of the correlation ε is bounded by:

$$E V {M}_{p o r t} \leq \sqrt{\frac{E V {M}_{1}^{2} E V {M}_{2}^{2} - 1 {0}^{8} \vert ε {\vert}^{2}}{E V {M}_{1}^{2} + E V {M}_{2}^{2} - 2 {10}^{4} \vert ε \vert}} , and \vert ε \vert \leq {σ}_{1} {σ}_{2} .$$

We the define ρ, 0≤ρ≤1, such that: |ε|=ρσ₁σ₂=ρ10⁻⁴EVM₁ EVM₂, where we have again used the fact that |ε|≤σ₁σ₂ because the covariance matrix is positive definite.

The port EVM can then be expressed as:

$${EVM}_{port} ( ρ ) \leq \sqrt{\frac{{EVM}_{1}^{2} {EVM}_{2}^{2} - {10}^{8} {\vert ε \vert}^{2}}{{EVM}_{1}^{2} + {EVM}_{2}^{2} - 2 {10}^{4} \vert ε \vert}} = \sqrt{\frac{{EVM}_{1}^{2} {EVM}_{2}^{2} - {ρ}^{2} {EVM}_{1}^{2} {EVM}_{2}^{2}}{{EVM}_{1}^{2} + {EVM}_{2}^{2} - 2 ρ {EVM}_{1} {EVM}_{2}}} = \sqrt{\frac{{EVM}_{1}^{2} {EVM}_{2}^{2}}{{EVM}_{1}^{2} + {EVM}_{2}^{2}} \frac{1 - {ρ}^{2}}{1 - \frac{2 ρ {EVM}_{1} {EVM}_{2}}{{EVM}_{1}^{2} + {EVM}_{2}^{2}}}}$$

More generally, if there is a definition:

$$β = \frac{min ( {EVM}_{1} , {EVM}_{2} )}{max ( {EVM}_{1} , {EVM}_{2} )} , then 0 < β \leq 1 ,$$

and the port EVM can be expressed as:

$${EVM}_{port} ( ρ ) \leq \sqrt{\frac{{max ( {EVM}_{1} , {EVM}_{2} )}^{4} {β}^{2}}{{max ( {EVM}_{1} , {EVM}_{2} )}^{2} ( 1 + {β}^{2} )} \frac{1 - {ρ}^{2}}{1 - \frac{2 {ρβmax ( {EVM}_{1} , {EVM}_{2} )}^{2}}{{max ( {EVM}_{1} , {EVM}_{2} )}^{2} ( 1 + {β}^{2}}}} = min ( {EVM}_{1} , {EVM}_{2} ) \sqrt{\frac{1 - {ρ}^{2}}{1 + {β}^{2} - 2 ρβ}} .$$

For the second term, subtraction of the numerator from the denominator yields

(1+β²−2ρβ)−(1−ρ²)=β²−2ρβ+ρ²=(β−ρ)²≥0.

Since the numerator is less than or equal to the denominator, it follows that

$$\sqrt{\frac{1 - {ρ}^{2}}{1 + {β}^{2} - 2 ρ β}} \leq 1.$$

Thus, EVMₚₒᵣₜ(ρ)≤min(EVM₁,EVM₂)—regardless of the value of the correlation coefficient ρ.

In the special case that β=1 so that EVM₁=EVM₂, we have:

$${EVM}_{port} ( ρ ) \leq {EVM}_{1} \sqrt{\frac{1 - {ρ}^{2}}{1 + {β}^{2} - 2 ρβ}} = {EVM}_{1} \sqrt{\frac{1 - {ρ}^{2}}{2 - 2 ρ}} = {EVM}_{1} \sqrt{\frac{1 + ρ}{2}} .$$

If the correlation coefficient is not known but is bounded by ρₘₐₓ, the worst case EVM for ρ≤ρₘₐₓ given by:

$${EVM}_{port , wc} ( {ρ}_{max} ) = {max}_{0 \leq ρ \leq {ρ}_{max}} {EVM}_{port} ( ρ ) .$$

To find the worst case EVM, it may be necessary to find a maximum:

$${max}_{0 \leq ρ \leq {ρ}_{max}} \sqrt{\frac{1 - {ρ}^{2}}{1 + {β}^{2} - 2 ρβ}} .$$

Squaring, taking the derivative and simplifying yields:

$$\frac{\partial }{\partial ρ} \{ \frac{1 - {ρ}^{2}}{1 + {β}^{2} - 2 ρ β} \} = \frac{( β - ρ ) ( 1 - ρ β )}{{( 1 + {β}^{2} - 2 ρ β )}^{2}} .$$

The denominator is positive for 0≤ρ<1. The numerator is equal to 0 for ρ=β, and is positive for ρ<β. Thus, we have:

$${EVM}_{port , wc} ( {ρ}_{max} ) = \{ \begin{matrix}min ( {EVM}_{1} , {EVM}_{2} \sqrt{\frac{1 - {ρ}_{max}^{2}}{1 + {β}^{2} - 2 {ρ}_{max} β}} & {ρ}_{max} \leq β \\ min ( {EVM}_{1} , {EVM}_{2} ) & {ρ}_{max} > β\end{matrix} ,$$

$$where \sqrt{\frac{1 - {ρ}_{max}^{2}}{1 + {β}^{2} - 2 {ρ}_{max} β}} \leq 1.$$

If the transmitter noise n at the two antenna connectors is independent so that the observed covariance matrix Σ= [symbol] n^{H}n [symbol] is diagonal, then the port EVM is given as:

$${EVM}_{port} = \sqrt{\frac{{EVM}_{1}^{2} {EVM}_{2}^{2}}{{EVM}_{1}^{2} + {EVM}_{2}^{2}}} ,$$

where EVM₁ and EVM₂ are the EVM values for the first and second antenna connectors. Furthermore, the per antenna EVM requirement can be set to be equal to EVM_{req}/\sqrt{2}, since if both EVM₁ and EVM₂ are less than this value, then EVMₚₒᵣₜ will be less than EVM_{req}.

If the correlation matrix Σ can be measured and is not diagonal, then the EVM for the port or layer can be computed either as: EVMₚₒᵣₜ=100·\sqrt{(w^{H}Σ⁻¹w)⁻¹}, or equivalently, as:

$${EVM}_{p o r t} = 100 \cdot {( {[ \begin{matrix}1 & 1\end{matrix} ]}^{H} {{\sum }^{′}}^{- 1} [ \begin{matrix}1 \\ 1\end{matrix} ] )}^{- \frac{1}{2}} ,$$

where w, Σ, and Σ′ are defined in various embodiments herein.

For two transmit antennas, if the correlation matrix Σ of the transmitter noise is not known but the maximum magnitude of the transmitter noise correlation coefficient ρ is bounded by ρ_{wc}, then:

$${EVM}_{port , wc} ( {ρ}_{w c} ) = \{ \begin{matrix}min ( {EVM}_{1} , {EVM}_{2} ) \sqrt{\frac{1 - {ρ}_{w c}^{2}}{1 + {β}^{2} - 2 {ρ}_{w c} β}} & {ρ}_{w c} \leq β \\ min ( {EVM}_{1} , {EVM}_{2} ) & {ρ}_{w c} > β\end{matrix} , where β = \frac{min ( {EVM}_{1} , {EVM}_{2} )}{max ( {EVM}_{1} , {EVM}_{2} )}$$

and it is always true that

$$\sqrt{\frac{1 - {ρ}_{w c}^{2}}{1 + {β}^{2} - 2 {ρ}_{w c} β}} \leq 1 .$$

If the number of transmit antennas is greater than two, or if the correlation matrix Σ of the transmitter noise is not known, then: EVMₚₒᵣₜ=min(EVM₁,EVM₂).

In some embodiments, a method used to define EVMₚₒᵣₜ may be determined by capabilities of test equipment. For example, if the test equipment can measure the correlation matrix of the antenna noise, then various embodiments herein may be used to define EVM for the antenna port. Alternatively, if the test equipment can only measure EVM₁ and EVM₂, but not a correlation matrix, then the port EVM may be defined per certain embodiments found herein.

It should be noted that, in some embodiments, a motivation for correctly defining the EVM for an antenna port is that the EVM definition is related to the maximum power reduction (“MPR”) or A-MPR that is needed to meet emissions requirements. Thus, if the MPR and/or A-MPR is not defined correctly, an amount of power that can be transmitted for a given constellation may be reduced.

In certain embodiments, EVM₁=EVM₂ and P₁=P₂. In such embodiments, the EVM may be: 1) Option 1: EVMₚₒᵣₜ=\sqrt{(P₁*EVM₁²+P₁*EVM₁²)/(P₁+P₁)}=EVM₁; or 2) Option 2: EVMₚₒᵣₜ=max(EVM₁,EVM₁)=EVM₁, so that the port EVM for both options is the same.

In some embodiments, if it is assumed that the noise at two antenna connectors is independent, then:

$${EVM}_{p o r t} = \sqrt{\frac{{EVM}_{1}^{2} {EVM}_{1}^{2}}{{EVM}_{1}^{2} + {EVM}_{2}^{2}}} = \frac{1}{\sqrt{2}} {EVM}_{1} .$$

As a result, the MPR required to achieve
a given port EVMₚₒᵣₜ is reduced since the values of EVM₁ and EVM₂ can be larger by \sqrt{2} and still meet the EVMₚₒᵣₜ requirement.

In various embodiments, if the noise at two antenna connectors is correlated and a covariance is unknown, then: EVMₚₒᵣₜ=min(EVM₁,EVM₂)=EVM₁.

In certain embodiments, there may be a benefit of relaxing a per antenna EVM by \sqrt{2}. Specifically, the MPR for an inner allocation may be as a function of EVM for CP-OFDM with QPSK, 16-QAM, 64-QAM, and 256-QAM. For example, if the EVM is relaxed by \sqrt{2}, the MPR may be reduced by 1 dB for 256-QAM and 64-QAM, and MPR can be reduced by 0.5 dB for 16-QAM.

In some embodiments, EVM₁=EVM₂/\sqrt{2} and P₁=P₂. In such embodiments, the EVM for Option 1 and Option 2 are as follows: 1) Option 1:

$${EVM}_{port} = \sqrt{( {P}_{1} * {EVM}_{1}^{2} / 2 + {P}_{1} * {EVM}_{2}^{2} ) / ( {P}_{1} + {P}_{1} )} = \frac{\sqrt{3}}{2} {EVM}_{2} ;$$

2) Option 2: EVMₚₒᵣₜ=max(EVM₂/\sqrt{2},EVM₂)=EVM₂.

In such embodiments, if it is assumed that the noise at the two antenna connectors is independent, then:

$${EVM}_{port} = \sqrt{\frac{( {EVM}_{2}^{2} / 2 ) {EVM}_{2}^{2}}{{EVM}_{2}^{2} / 2 + {EVM}_{2}^{2}}} = \frac{1}{\sqrt{3}} {EVM}_{2} .$$

Because EVMₚₒᵣₜ is a factor of 1.5 ((\sqrt{3}/2)/(1/\sqrt{3})) less than EVMₚₒᵣₜ for Option 1, EVM₁ and EVM₂ can be larger by a factor of 1.5 and still meet the same EVMₚₒᵣₜ requirement. Similarly, because EVMₚₒᵣₜ is a factor of \sqrt{3}(1/(1/\sqrt{3})) less than EVMₚₒᵣₜ for Option 2, EVM₁ and EVM₂ can be larger by a factor of \sqrt{3} and still meet the same EVMₚₒᵣₜ requirement.

In various embodiments, if is assumed that the noise at the two antenna connectors is correlated and the covariance is unknown, then: EVMₚₒᵣₜ=min(EVM₂/\sqrt{2},EVM₂)=EVM₂/\sqrt{2}.

Because EVMₚₒᵣₜ is a factor of \sqrt{3/2}((\sqrt{3}/2)/(1/\sqrt{2}) less than EVMₚₒᵣₜ for Option 1, it follows that EVM₁ and EVM₂ can be larger by a factor of \sqrt{3/2} and still meet the same EVMₚₒᵣₜ requirement. Similarly, because EVMₚₒᵣₜ is a factor of \sqrt{2} less than EVMₚₒᵣₜ for Option 2, it follows that EVM₁ and EVM₂ can be larger by a factor of \sqrt{2} if and still meet the same EVMₚₒᵣₜ requirement as Option 2.

In some embodiments, an antenna port includes two physical antennas and there are two receive antennas. However, this can be extended to an arbitrary number of physical antennas per port so long as the receiver has the same number of antennas. Specifically, the two expressions for the port EVM are given by:

$${EVM}_{p o r t} = 100 \cdot \sqrt{{( {w}^{H} {\sum }^{- 1} w )}^{- 1}} , and {EVM}_{p o r t} = 100 \cdot {( {[ \begin{matrix}1 \\ 1\end{matrix} ]}^{H} {\sum }^{′ - 1} [ \begin{matrix}1 \\ 1\end{matrix} ] )}^{- \frac{1}{2}} ,$$

where w, Σ, and Σ′ are defined as:

$$z = w x + n , [ \begin{matrix}{w}_{1} \\ {w}_{2}\end{matrix} ] = [ \begin{matrix}{g}_{l} & {w}_{1}^{′} \\ {g}_{2} & {w}_{2}^{′}\end{matrix} ] , \sum = E ( {n}^{H} n ) , {n}^{′} = [ \begin{matrix}{n}_{1}^{′} \\ {n}_{2}^{′}\end{matrix} ] = [ \begin{matrix}{\hat{w}}_{1}^{- 1} & {n}_{1} \\ {\hat{w}}_{2}^{- 1} & {n}_{2}\end{matrix} ] , and {\sum }^{′} = 〈 {n}^{′ H} {n}^{′} 〉 .$$

The vectors w′, ŵ, and g can be found based on calculation performed per FIGS. 4 and 5. It should be noted that all of the vectors and matrices in these expressions scale with the number of physical antennas used to implement the antenna port. That is, if there are N physical antennas, then the vectors w, n, w′, n′ all have dimension N×1. Similarly, if there are N physical antennas, the matrices Σ, and Σ′ have dimension N×N. The only modification that is needed is for the equation:

$${EVM}_{p o r t} = 100 \cdot {( {[ \begin{matrix}1 \\ 1\end{matrix} ]}^{H} {\sum }^{{′ - 1}^{}} [ \begin{matrix}1 \\ 1\end{matrix} ] )}^{- \frac{1}{2}} .$$

As written, with the 2×1 matrices [1 1] and [1 1]^{H}, this equation only applies for two physical antennas. To extend to the general case of N antennas, let 1_{N×M} denote a matrix of dimension N×M having all entries equal to 1. With this definition, this port definition can be extended to the case of N physical transmit antennas as:

$${EVM}_{p o r t} = 100 \cdot {( {1}_{1 \times N} {\sum }^{′ - 1} {1}_{N \times 1} )}^{- \frac{1}{2}} .$$

For two antennas, if the transmitter noise is observed to be independent at the antenna connectors so that the observed covariance matrix Σ= [symbol] n^{H}n [symbol] is diagonal, then the port EVM is given as

$${EVM}_{port} = \sqrt{\frac{{EVM}_{1}^{2} {EVM}_{2}^{2}}{{EVM}_{1}^{2} + {EVM}_{2}^{2}}} .$$

Some embodiments described herein may be extended to N antennas (e.g., assuming N antennas at the receiver and a linear unbiased MMSE receiver) as in the following:

$${EVM}_{p o r t} = 100 \cdot {( {1}_{1 \times N} {\sum }^{′ - 1} {1}_{N \times 1} )}^{- \frac{1}{2}} = {( {\sum }_{i = 1}^{N} \frac{1}{{EVM}_{i}^{2}} )}^{- \frac{1}{2}} = {( \frac{{\prod }_{i = 1}^{N} {EVM}_{i}^{2}}{{\sum }_{i = 1}^{N} {\prod }_{j = 1 , j \neq i}^{N} {EVM}_{j}^{2}} )}^{\frac{1}{2}} .$$

So that an equation for N transmit antennas is given as:

$${EVM}_{port} = {( \frac{{\sum }_{i = 1}^{N} {\prod }_{j = 1 , j \neq i}^{N} {EVM}_{j}^{2}}{{\sum }_{i = 1}^{N} {EVM}_{i}^{2}} )}^{\frac{1}{2}} .$$

If

$${EVM}_{1} = {EVM}_{2} = … = {EVM}_{N} , then {EVM}_{p o r t} = {( \frac{{\sum }_{i = 1}^{N} {\prod }_{j = 1 , j \neq i}^{N} {EVM}_{j}^{2}}{{\sum }_{i = 1}^{N} {EVM}_{i}^{2}} )}^{\frac{1}{2}} = \frac{{EVM}_{1}}{\sqrt{N}} .$$

In various embodiments, transmitter noise is correlated but the correlation is unknown and may be extended to an arbitrary number of antennas. For two antennas, an EVMₚₒᵣₜ may be defined as: EVMₚₒᵣₜ≤min(EVM₁,EVM₂).

This may be the result of maximizing a general EVM expression:

$${EVM}_{p o r t} = 100 \cdot {( {1}_{1 \times N} {\sum }^{′ - 1} {1}_{N \times 1} )}^{- \frac{1}{2}}$$

over a set of allowed covariance values ε. For N antennas, a bound on EVMₚₒᵣₜ may be derived. If a number of receive antennas is equal to a number of transmit antennas and a channel H between the transmitter and the receiver is invertible, then the receiver can invert the channel and select the transmitter output with the smallest EVM. As a result, if the transmitter and the receiver have N antennas and the correlation of the transmitter noise is unknown, then: EVMₚₒᵣₜ=min(EVM₁, EVM₂, . . . , EVM_{N}) resulting in a relaxed per antenna EVM and reduced MPR for transmitting from an antenna port with more than one antenna.

In certain embodiments, if the transmitter noise is uncorrelated, the difference between

$${EVM}_{p o r t} = \frac{{EVM}_{1}^{2} {EVM}_{2}^{2}}{{EVM}_{1}^{2} + {EVM}_{2}^{2}}$$

and max(EVM₁, EVM₂) may be equal to 3 dB if EVM₁=EVM₂. As a result, if the per antenna EVM is relaxed by 3 dB relative to the desired port EVM, the port EVM requirement may still be met. More generally, with N transmit and N receive antennas and uncorrelated transmitter noise, an antenna EVM may be relaxed by 10 log₁₀ N dB relative to the desired port EVM and the port EVM requirement may still be met.

To show this embodiment explicitly, let EVM_{req}(m) denotes the single antenna EVM requirement for the given modulation type m and note that this same requirement must be met by the antenna port. For two transmit antennas and the transmitter noise may be uncorrelated. Let the per antenna EVM requirements be set as: EVM₁=EVM₂=\sqrt{2} EVM_{req}(m), where EVM_{req}(m) is the port EVM requirement for the modulation m. If the transmitter noise is uncorrelated, then:

$${EVM}_{port} = \sqrt{\frac{{( \sqrt{2} {EVM}_{r e q} ( m ) )}^{2} {( \sqrt{2} {EVM}_{r e q} ( m ) )}^{2}}{{( \sqrt{2} {EVM}_{r e q} ( m ) )}^{2} + {( \sqrt{2} {EVM}_{r e q} ( m ) )}^{2}}} = {EVM}_{r e q} ( m )$$

and EVMₚₒᵣₜ is equal to the EVM requirement EVM_{req}(m) for the modulation type.

More generally, for N transmit antennas and N receive antennas (assuming a linear unbiased MMSE receiver is used), let: EVM₁=EVM₂= . . . =EVM_{N}=\sqrt{N} EVM_{req}(m), where EVM_{req} denotes the single antenna EVM requirement for the given modulation type. If the transmitter noise is uncorrelated, then:

$${EVM}_{port} = {( \frac{{Σ}_{i = 1}^{N} {Π}_{j = 1 , j \neq i}^{N} \sqrt{N} {EVM}_{r e q}^{2} ( m )}{{Σ}_{i = 1}^{N} \sqrt{N} {EVM}_{r e q}^{2} ( m )} )}^{\frac{1}{2}} = {EVM}_{r e q} ( m )$$

and EVMₚₒᵣₜ is equal to the EVM requirement EVM_{req}(m) for the modulation.

By relaxing the EVM requirement by a factor of \sqrt{2}, the MPR can be reduced by approximately 1 dB for 256-QAM and 64-QAM, and 0.5 dB for 16 QAM. Thus, if it is assumed that the transmitter noise is uncorrelated, then the port EVM for two transmit antennas may be defined as:

$${EVM}_{p o r t} = \sqrt{\frac{{EVM}_{1}^{2} {EVM}_{2}^{2}}{{EVM}_{1}^{2} + {EVM}_{2}^{2}}} .$$

In various embodiments, if EVM_{req} denotes the EVM requirement for the given modulation, then setting EVM₁≤\sqrt{2}EVM_{req}(m) and EVM₂≤\sqrt{2}EVM_{req}(m) will result in EVMₚₒᵣₜ≤EVM_{req}(m).

Furthermore, for each modulation type m, single antenna MPR may defined for an EVM requirement equal to \sqrt{2}EVM_{req}(m) where EVM_{req}(m) is the single antenna EVM requirement for modulation type m. Moreover, for a UE transmitting modulation type m on an antenna port comprised of two antennas, the per antenna MPR may be limited to the MPR corresponding to \sqrt{2}EVM_{req}(m).

In certain embodiments, there may be two transmit antennas where a transmitter correlation is not known, but is bounded by ρ_{wc} (where 0≤ρ_{wc}≤1). In such embodiments, an EVM requirement for an antenna port is given by EVM_{req}(m) where m is the modulation type. Further, per antenna EVM requirements may be equal to:

$${EVM}_{1} = \sqrt{\frac{2}{1 + {ρ}_{w c}}} {EVM}_{r e q} ( m ) and {EVM}_{2} = \sqrt{\frac{2}{1 + {ρ}_{w c}}} {EVM}_{r e q} ( m ) .$$

$$Thus :$$

$${EVM}_{port} ( ρ ) \leq \sqrt{\frac{{EVM}_{1}^{2} {EVM}_{2}^{2} - {ρ}^{2} {EVM}_{1}^{2} {EVM}_{2}^{2}}{{EVM}_{1}^{2} + {EVM}_{2}^{2} - 2 ρ {EVM}_{1} {EVM}_{2}}} = \sqrt{\frac{{( \frac{2}{1 + {ρ}_{w c}} )}^{2} {EVM}_{r e q}^{4} ( m ) ( 1 - {ρ}^{2} )}{2 ( \frac{2}{1 + {ρ}_{w c}} ) {EVM}_{r e q}^{2} ( m ) ( 1 - ρ )}} = {EVM}_{r e q} ( m ) \sqrt{\frac{( \frac{2}{1 + {ρ}_{w c}} ) ( 1 + ρ )}{2}} = {EVM}_{r e q} ( m ) \sqrt{\frac{1 + ρ}{1 + {ρ}_{w c}}} .$$

So, as long ρ≤ρ_{wc}, then EVMₚₒᵣₜ(ρ)≤EVM_{req}(m), where EVM_{req}(m) is the EVM requirement for the given modulation type. Since

$$\sqrt{\frac{2}{1 + {ρ}_{w c}}} \geq 1 ,$$

the requirements for EVM₁ and EVM₂ are relaxed relative to EVM_{req}(m), and the MPR needed to meet the per antenna EVM requirements is reduced.

It should be noted that embodiments herein may not apply to multi-layer multiple input multiple output (“MIMO”) transmission. In some embodiments, an MPR needed for a given modulation type may be different for single layer transmission than for dual layer transmission. In various embodiments, MPR may be defined per-antenna per modulation type for single-layer modulation using an EVM expression.

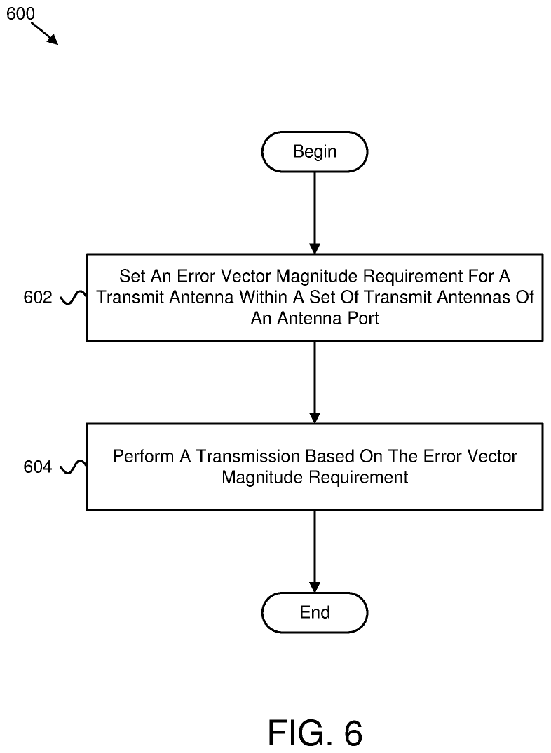

FIG. 6 is a flow chart diagram illustrating one embodiment of a method 600 for meeting an error vector magnitude requirement. In some embodiments, the method 600 is performed by an apparatus, such as the remote unit 102 and/or the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes setting 602 an error vector magnitude requirement for a transmit antenna within a set of transmit antennas of an antenna port. The error vector magnitude requirement for the transmit antenna is a EVM_{req}(m); EVM_{req} is the error vector magnitude requirement for the antenna port for a modulation; and a is based on a function of a number of transmit antennas of the antenna port. In some embodiments, the method 600 includes performing 604 a transmission based on the error vector magnitude requirement.

In certain embodiments, the number of antennas of the antenna port is N, and a is equal to \sqrt{N}. In some embodiments, the number of antennas of the antenna port is two, a is equal to

$$\sqrt{\frac{2}{1 + {ρ}_{w c}}} {EVM}_{r e q} ( m ) ,$$

ρ_{wc} is a correlation coefficient of transmitter noise, and EVM_{req}(m) is the antenna port error vector magnitude requirement for modulation type m.

In various embodiments, the device comprises a user equipment. In one embodiment, the device comprises a network device.

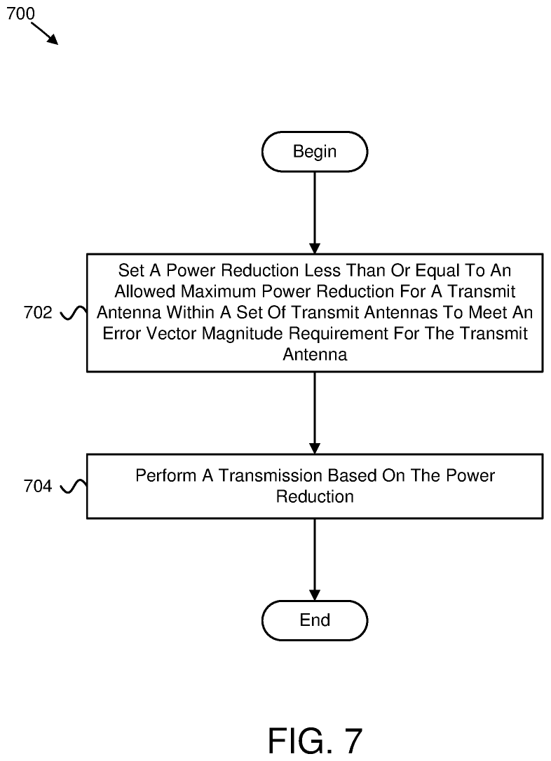

FIG. 7 is a flow chart diagram illustrating another embodiment of a method 700 for meeting an error vector magnitude requirement. In some embodiments, the method 700 is performed by an apparatus, such as the remote unit 102 and/or the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes setting 702 a power reduction less than or equal to an allowed maximum power reduction for a transmit antenna within a set of transmit antennas to meet an error vector magnitude requirement for the transmit antenna. The error vector magnitude requirement for the transmit antenna is a EVM_{req}(m); EVM_{req} is the error vector magnitude requirement for the antenna port for a modulation; and a is based on a function of a number of transmit antennas of the antenna port. In some embodiments, the method 700 includes performing 704 a transmission based on the power reduction.

In certain embodiments, the number of antennas of the antenna port is N, and a is equal to \sqrt{N}. In some embodiments, the number of antennas of the antenna port is two, a is equal to

$$\sqrt{\frac{2}{1 + {ρ}_{w c}}} {EVM}_{r e q} ( m ) ,$$

ρ_{wc} is a correlation coefficient of transmitter noise, and EVM_{req}(m) is the antenna port error vector magnitude requirement for modulation type m.

In various embodiments, the device comprises a user equipment. In one embodiment, the device comprises a network device.

In one embodiment, a method of a device comprises: setting an error vector magnitude requirement for a transmit antenna within a set of transmit antennas of an antenna port, wherein: the error vector magnitude requirement for the transmit antenna is a EVM_{req}(m); EVM_{req} is the error vector magnitude requirement for the antenna port for a modulation; and a is based on a function of a number of transmit antennas of the antenna port; and performing a transmission based on the error vector magnitude requirement.

In certain embodiments, the number of antennas of the antenna port is N, and a is equal to \sqrt{N}.

In some embodiments, the number of antennas of the antenna port is two, a is equal to

$$\sqrt{\frac{2}{1 + {ρ}_{w c}}} {EVM}_{r e q} ( m ) ,$$

ρ_{wc} is a correlation coefficient of transmitter noise, and EVM_{req}(m) is the antenna port error vector magnitude requirement for modulation type m.

In various embodiments, the device comprises a user equipment.

In one embodiment, the device comprises a network device.

In one embodiment, an apparatus comprises a device. The apparatus further comprises: a processor that: sets an error vector magnitude requirement for a transmit antenna within a set of transmit antennas of an antenna port, wherein: the error vector magnitude requirement for the transmit antenna is a EVM_{req}(m); EVM_{req} is the error vector magnitude requirement for the antenna port for a modulation; and a is based on a function of a number of transmit antennas of the antenna port; and performs a transmission based on the error vector magnitude requirement.

In certain embodiments, the number of antennas of the antenna port is N, and a is equal to \sqrt{N}.

In some embodiments, the number of antennas of the antenna port is two, a is equal to

$$\sqrt{\frac{2}{1 + {ρ}_{w c}}} {EVM}_{r e q} ( m ) ,$$

ρ_{wc} is a correlation coefficient of transmitter noise, and EVM_{req}(m) is the antenna port error vector magnitude requirement for modulation type m.

In various embodiments, the device comprises a user equipment.

In one embodiment, the device comprises a network device.

In one embodiment, a method of a device comprises: setting a power reduction less than or equal to an allowed maximum power reduction for a transmit antenna within a set of transmit antennas to meet an error vector magnitude requirement for the transmit antenna, wherein: the error vector magnitude requirement for the transmit antenna is a EVM_{req}(m); EVM_{req} is the error vector magnitude requirement for the antenna port for a modulation; and a is based on a function of a number of transmit antennas of the antenna port; and performing a transmission based on the power reduction.

In certain embodiments, the number of antennas of the antenna port is N, and a is equal to \sqrt{N}.

In some embodiments, the number of antennas of the antenna port is two, a is equal to

$$\sqrt{\frac{2}{1 + {ρ}_{w c}}} {EVM}_{r e q} ( m ) ,$$

ρ_{wc} is a correlation coefficient of transmitter noise, and EVM_{req}(m) is the antenna port error vector magnitude requirement for modulation type m.

In various embodiments, the device comprises a user equipment.

In one embodiment, the device comprises a network device.

In one embodiment, an apparatus comprises a device. The apparatus further comprises: a processor that: sets a power reduction less than or equal to an allowed maximum power reduction for a transmit antenna within a set of transmit antennas to meet an error vector magnitude requirement for the transmit antenna, wherein: the error vector magnitude requirement for the transmit antenna is a EVM_{req}(m); EVM_{req} is the error vector magnitude requirement for the antenna port for a modulation; and a is based on a function of a number of transmit antennas of the antenna port; and performs a transmission based on the power reduction.

In certain embodiments, the number of antennas of the antenna port is N, and a is equal to \sqrt{N}.

In some embodiments, the number of antennas of the antenna port is two, a is equal to

$$\sqrt{\frac{2}{1 + {ρ}_{w c}}} {EVM}_{r e q} ( m ) ,$$

ρ_{wc} is a correlation coefficient of transmitter noise, and EVM_{req}(m) is the antenna port error vector magnitude requirement for modulation type m.

In various embodiments, the device comprises a user equipment.

In one embodiment, the device comprises a network device.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method at a device, the method comprising:
setting an error vector magnitude (EVM) requirement for a transmit antenna within a set of transmit antennas of an antenna port, wherein:
the EVM requirement for the transmit antenna is a EVM_{req}(m);
EVM_{req} is the EVM requirement for the antenna port for a modulation; and
a is based on a function of a number of transmit antennas of the antenna port; and
performing a transmission based on the EVM requirement.

2. The method of claim 1, wherein the number of antennas of the antenna port is N, and a is equal to \sqrt{N}.

3. The method of claim 1, wherein the number of antennas of the antenna port is two, a is equal to
$$\sqrt{\frac{2}{1 + {ρ}_{w c}}} {EVM}_{r e q} ( m ) ,$$
ρ_{wc} is a correlation coefficient of transmitter noise, and EVM_{req}(m) is the antenna port EVM requirement for modulation type m.

4. The method of claim 1, wherein the device comprises a user equipment (UE).

5. The method of claim 1, wherein the device comprises a network device.

6. An apparatus for wireless communication, the apparatus comprising:
a processor; and
a memory coupled to the processor, the memory comprising instructions executable by the processor to cause the apparatus to:
set an error vector magnitude requirement for a transmit antenna within a set of transmit antennas of an antenna port, wherein:
the EVM requirement for the transmit antenna is a EVM_{req}(m);
EVM_{req} is the EVM requirement for the antenna port for a modulation; and
a is based on a function of a number of transmit antennas of the antenna port; and
perform a transmission based on the EVM requirement.

7. The apparatus of claim 6, wherein the number of antennas of the antenna port is N, and a is equal to \sqrt{N}.

8. The apparatus of claim 6, wherein the number of antennas of the antenna port is two, a is equal to
$$\sqrt{\frac{2}{1 + {ρ}_{w c}}} {EVM}_{r e q} ( m ) ,$$
ρ_{wc} is a correlation coefficient of transmitter noise, and EVM_{req}(m) is the antenna port EVM requirement for modulation type m.

9. The apparatus of claim 6, wherein the apparatus comprises a user equipment (UE).

10. The apparatus of claim 6, wherein the apparatus comprises a network device.

11. An apparatus for wireless communication, the apparatus comprising:
a processor; and
a memory coupled to the processor, the memory comprising instructions executable by the processor to cause the apparatus to:
set a power reduction less than or equal to an allowed maximum power reduction for a transmit antenna within a set of transmit antennas to meet an error vector magnitude (EVM) requirement for the transmit antenna, wherein:
the EVM requirement for the transmit antenna is a EVM_{req}(m);
EVM_{req} is the EVM requirement for the antenna port for a modulation; and
a is based on a function of a number of transmit antennas of the antenna port; and
perform a transmission based on the power reduction.

12. The apparatus of claim 11, wherein the number of antennas of the antenna port is N, and a is equal to \sqrt{N}.

13. The apparatus of claim 11, wherein the number of antennas of the antenna port is two, a is equal to
$$\sqrt{\frac{2}{1 + {ρ}_{w c}}} {EVM}_{r e q} ( m ) ,$$
ρ_{wc} is a correlation coefficient of transmitter noise, and EVM_{req}(m) is the antenna port EVM requirement for modulation type m.

14. The apparatus of claim 11, wherein the apparatus comprises a user equipment (UE).

15. The apparatus of claim 11, wherein the apparatus comprises a network device.
